(19) United States
(12) Patent Application Publication
(10) Pub. No.: US 2012/0060647 A1
(43) Pub. Date: Mar. 15, 2012

(54) GEAR DEVICE AND METHOD OF MANUFACTURING SHAFT MEMBER

(75) Inventor: Akira YAMAMOTO, Obu-shi (JP)

(73) Assignee: SUMITOMO HEAVY INDUSTRIES, LTD., Tokyo (JP)

(21) Appl. No.: 13/213,123

(22) Filed: Aug. 19, 2011

(30) Foreign Application Priority Data
Sep. 14, 2010 (JP) 2010-206142

(51) Int. Cl. F16H 1/02; B21D 53/28

(52) U.S. Cl. 74/640; 72/352

(57) ABSTRACT

A gear device which has a shaft member including a gear portion and a shaft portion formed consecutively and integrally with the gear portion; and a fitting member that may be fitted into the shaft portion of the shaft member, wherein, in the shaft member, at least the gear portion may be formed by a plastic working, a guard portion protruding from a addendum circle of the gear portion to an outer side in the radial direction may be formed in an end portion of a shaft portion side of an axial direction of the gear portion, and the movement in the axial direction of the fitting member may be restricted by the guard portion.

### BACKGROUND

1. Technical Field

The present invention relates to a gear device and a method of manufacturing a shaft member.

Priority is claimed to Japanese Patent Application No. 2010-206142, filed Sep. 14, 2010, the entire content of each of which is incorporated herein by reference.

2. Description of the Related Art

For example, the related art discloses a gear device that includes a shaft member as shown in FIG. 6.

In a gear device 10, the rotation of a carrier body of a preceding stage is transmitted to an orthogonal deceleration mechanism 18 of a later stage via a shaft member 16, and the deceleration rotation is extracted from an output shaft 20. The shaft member 16 includes a bevel pinion portion (a gear portion) 16A, and a shaft portion 16B that is formed continuously and integrally with the bevel pinion portion 16A. The carrier body 12 and the shaft member 16 are supported by a configuration capable of receiving thrust force in the axial direction by a pair of first and second conical roller bearings 24 and 26 in a freely rotatable manner.

The first conical roller bearing 24 of the carrier body 12 side has a relatively large inner diameter D1, but the second conical roller bearing 26 of the shaft member 16 side has a considerably small inner diameter D2. This is because the bevel pinion portion 16A of the shaft member 16 is formed by cutting, in view of the need to secure a space of “removal of a tool” during cutting, it is not possible to make the outer diameter d2 (=D2) of the shaft portion 16B of the shaft member 16 greater than a root circle diameter d1 of the bevel pinion portion 16A.

In addition, in the example of the related art, one is used in which the outer diameter d2 of the shaft portion 16B of the shaft member 16 is smaller than the root circle diameter d1, and an end portion 16A1 of the bevel pinion portion 16A is used as a positioning surface with the second conical roller bearing 26.

### SUMMARY

According to an embodiment of the present invention, there is provided a gear device which has a shaft member including a gear portion and a shaft portion formed consecutively and integrally with the gear portion; and a fitting member that is fitted into the shaft portion of the shaft member, wherein, in the shaft member, at least the gear portion is formed by a plastic working, a guard portion protruding from the addendum circle of the gear portion to an outer side of a diameter direction is formed in an end portion of a shaft portion side of an axial direction of the gear portion, and the movement in the axial direction of the fitting member is restricted by the guard portion.

From the same viewpoint, according to another embodiment of the invention, there is provided a method of manufacturing a shaft member having a shaft portion integrally formed with a gear portion, including the steps of preparing a material of the shaft member; and plastically deforming the material of the shaft member by forging to form a tooth form of the gear portion and forming a guard portion having an external diameter greater than a addendum circle of the gear portion and the shaft portion to be connected to the guard portion by an external diameter smaller than the external diameter of the guard portion.

Furthermore, according to still another embodiment of the present invention, there is provided a method of manufacturing a shaft member having a shaft portion integrally formed with a gear portion, including the steps of preparing a material of the shaft member including a large diameter portion of a large diameter in a middle portion of an axial direction; and plastically deforming the material of the shaft member by rolling to form a tooth form of the gear portion in an axial direction one side of the large diameter portion, and leaving the large diameter portion as a guard portion greater than the addendum circle of the gear portion and the shaft portion connecting a counter guard portion side of the large diameter portion to the guard portion by an external diameter smaller than the external diameter of the guard portion.

### BRIEF DESCRIPTION OF THE DRAWINGS

FIG. 1 is a partial cross-sectional diagram of a gear device that shows an example of an embodiment of the present invention.

FIG. 2 is a partial cross-sectional diagram of a gear device that shows an example of another embodiment of the present invention.

FIG. 3 is a partial cross-sectional diagram of a gear device that shows an example of still another embodiment of the present invention.

FIG. 4 is a schematic diagram when manufacturing a shaft member of a gear device according to an embodiment of the present invention by forging or rolling.

FIG. 5 is a partial cross-sectional diagram of a gear device corresponding to an example of related art of the embodiment of FIG. 3.

FIG. 6 is a partial cross-sectional diagram of a gear device corresponding to an example of related art of the embodiment of FIG. 1.

### DETAILED DESCRIPTION

As in the example of the related art, for example, when the inner diameter D1 of the first conical roller bearing 24 of the carrier body 12 side of the pair of conical roller bearings 24 and 26 is a relatively large diameter, in order increase the balance or the stability of the support, there is a demand that the inner diameter D2 of the second conical roller bearing 26 of the shaft member 16 side is also correspondently enlarged.

However, owing to the reason described above, in forming the outer diameter d2 (=D2) of the shaft portion 16B of the shaft member 16 at a size close to the inner diameter D1, there is a need to increase the size of the bevel pinion portion 16A more than necessary or gradually secure an removal space of a tool (that is, a shaft portion having a diameter smaller than the root circle diameter d1 of the bevel pinion portion 16A) in the axial direction and continuously form a shaft portion having a large diameter thereon.

Of course, when making the size of the bevel pinion portion increase more than necessary, increases in weight and cost are caused accordingly. Furthermore, when lengthening a shaft length of the shaft member more than necessary so as to secure a removal space of a tool, an increase in length in the axial direction of the overall gear device is caused accordingly. Additionally, the size of forming a thin portion of the shaft diameter by the corresponding amount of the removal becomes a concave portion as a consequence of the thin portion of the shaft diameter, and since it is not possible to “use the end portions of the gear portion as the positioning surface of the bearing” that can be realized in the example of the related art, there is a problem in that certain positioning unit should be separately prepared for the positioning of the bearing.

It is desirable to obtain a gear device that can improve the degree of design freedom of the outer diameter of a shaft portion without increasing a shaft length of a shaft member and can perform a position regulation of a fitting member such as a bearing without requiring separate positioning unit or the like, and a method of manufacturing the shaft member which becomes the core of the gear device.

When forming the gear portion by plastic working such as forging or rolling, it is possible to form the shaft member having the shaft portion of the large diameter that is not restricted to the size of the gear portion. Furthermore, at that time, it is also possible to intentionally form a guard portion protruding from the addendum circle of the gear portion to an outer side in the radial direction in the end portion of the axial direction shaft portion side of the gear portion. Particularly, when the gear portion is formed by plastic deformation due to the forging, in many cases, a ring-like protrusion portion is additionally formed in a normal manufacturing process. However, in the case of the present invention, the ring-like protrusion portion is actively formed and utilized as “a guard portion” having the outer diameter larger than the addendum circle diameter, and is used as “a positioning surface” for restricting the movement of the fitting member such as a bearing.

In the viewpoint, the present invention can form the guard portion having the outer diameter greater than the addendum circle diameter of the gear portion without interruption, in the case of forming the gear portion by plastic working.

According to the embodiments of the present invention, it is possible to obtain a gear device which can improve the degree of design freedom of the outer diameter of a shaft portion without increasing a shaft length of a shaft member and can perform a position regulation of a fitting member, such as a bearing, without requiring separate positioning unit or the like, or a method of manufacturing the shaft member which becomes the core thereof.

Hereinafter, an embodiment of the present invention will be described in detail with reference to the drawings.

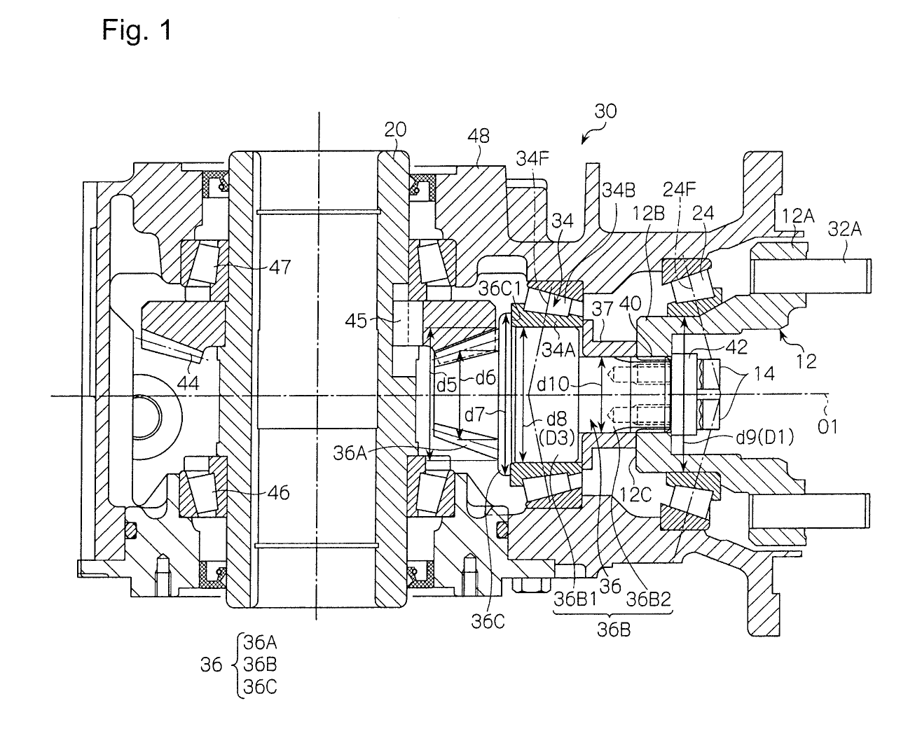

FIG. 1 is a partial cross-sectional view of a gear device according to an example of an embodiment of the present invention.

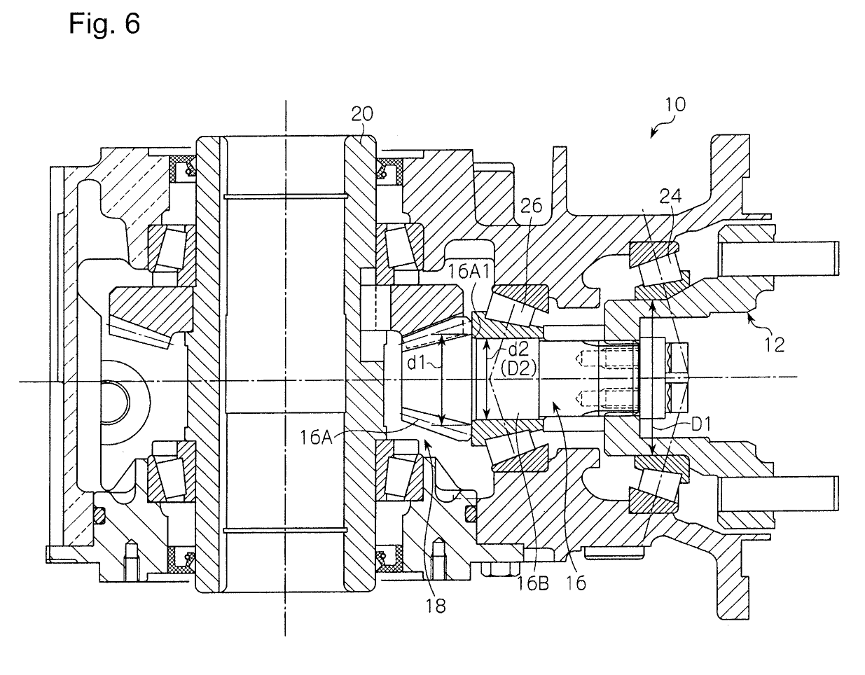

In addition, in order to facilitate the understanding, members identical to a gear device of the related art shown in FIG. 6 are denoted by the same reference numerals for convenience.

Even in a gear device 30, the rotation of a carrier body 12 of a front state is transmitted to an orthogonal deceleration mechanism 18 of a rear state via a shaft member 36, and a deceleration rotation is obtained from an output shaft 20.

A shaft member 36 includes a bevel pinion portion (a gear portion) 36A and a cylindrical shaft portion 36B that is connected to the bevel pinion portion 36A and is formed integrally therewith. The shaft portion 36B includes a first shaft portion 36B1 of the gear portion side, and a second shaft portion 36B2 of the carrier body side.

In the gear device 30, the rotation of the carrier body 12, into which a planetary pin 32 of a simple planetary gear portion mechanism (not shown) is pressure-fitted, is transmitted to the shaft member 36 fixed to the carrier body 12. The carrier body 12 includes a flange portion 12A and a barrel-like portion 12B into which the planetary pin 32 is pressure-fitted, and a first conical roller bearing 24 (that is the other of the pair of conical roller bearing) is included in the barrel-like portion 12B. The inner diameter of the first conical roller bearing 24 is Dl.

The carrier body 12 and the shaft member 36 are connected to each other via a spline 40 in a circumferential direction, and is fixed via a bolt 14 in an axial direction. The fixing of the axial direction will be described in detail. Between a guard portion 36C described later of the shaft member 36 and an end surface 12C of the carrier body 12, an inner rim 34A of a second conical roller bearing 34 (that is the other side of a pair of conical roller bearings) and a spacer 37 are interposed. In this state, when the bolt 14 is penetrated through a pedestal 42 (that comes into contact with the carrier body 12) and is screwed into the end surface of the shaft member 36, the shaft member 36 is attracted to the carrier body 12 side and is fixed in the axial direction. The bolt 14 is able to adjust and maintain pressurization of the second conical roller bearing 34 to the optimal value by adjusting the screwing amount.

Thus, in the present embodiment, the inner rim 34A of the second conical roller bearing 34 corresponds to “a fitting member which is fitted into the shaft member 36 and in which the movement in the axial direction is restricted by the guard portion 36C”.

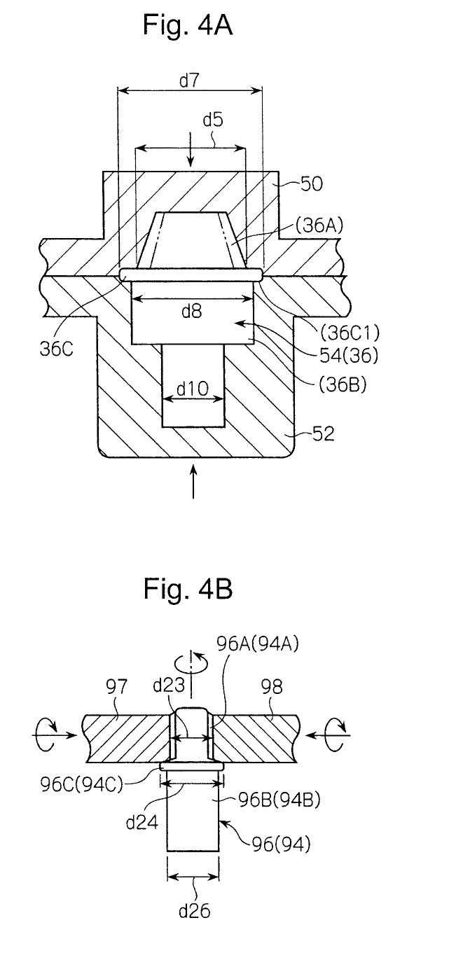

As schematically shown in FIG. 4A, the shaft member 36 is formed by plastically deforming a shaft material 54, by “forging (cold-forging in the present embodiment)” that pressure-interposes the shaft material 54 which is a material of the shaft member 36 by a shocking strong pressure by a pair of forging molds 50 and 52. In addition, there is also a case of shaping in a multi-step manner while changing the kind of forging mold.

In the process of the forging, in the end portion of the axial direction shaft portion 36B side of the bevel pinion portion 36A, a circular guard portion 36C is concurrently formed which (an outer periphery shaft) is protruded from the addendum circle (a addendum circle diameter d5) of the bevel pinion portion 36A to the outer side of the radial direction. The outer diameter of the guard portion 36C relative to the addendum circle diameter d5 is d7, and “the addendum circle diameter d5 <the outer diameter d7”.

In addition, the outer diameter of the first shaft portion 36B1 of the shaft portion 36B is d8, and is smaller than the outer diameter d7 of the guard portion 36C (d7>d8). That is, in the shaft portion 36B side of the guard portion 36C, a large positioning surface (step portion) 36C1 equivalent to the diameter difference (d7−d8) is formed. In addition, the outer diameter d8 of the first shaft portion 36B1 is greater than the addendum circle diameter d5 (of course, the outer diameter d8 is greater than the root circle diameter d6). Furthermore, the outer diameter of the second shaft portion 36B2 of the counter gear portion side of the shaft portion 36B is d10 (that is thin similar to the related art).

Returning to FIG. 1, the outer diameter d8 of the first shaft portion 36B1 of the shaft portion 36B of the shaft member 36 corresponds to the inner diameter D3 of the second conical roller bearing 34, but the inner diameter D3 has the size that is not excessively changed from the outer diameter d9 (=D1) of the barrel-like portion 12B of the carrier body 12 (D3≅D1).

The bevel pinion portion 36A is engaged with the bevel gear 44. The bevel gear 44 is connected to the output shaft 20 via a key 45. In addition, the output shaft 20 is supported on a casing 48 via a pair of conical roller bearings 46 and 47 in a freely rotatable manner.

Next, an operation of the gear device 30 according to the embodiment will be described.

When the rotation of a simple planetary gear mechanism (not shown) is transmitted to the carrier body 12 via the planetary pin 32, the shaft member 36 is rotated at the same rotational speed as that of the carrier body 12 via the spline 40. When the shaft member 36 is rotated, the bevel pinion portion 36A of the tip thereof is rotated, and the bevel gear 44 engaged with the bevel pinion portion 36A is rotated. The rotation of the bevel gear 44 is obtained as the rotation of the output shaft 20 via the key 45.

Herein, the tooth form (an umbrella tooth) of the bevel pinion portion (the gear portion) 36A according to the present embodiment is formed by plastically deforming the shaft material 54 by forging. Thus, it is possible to easily form the guard portion 36C that has the outer diameter d7 greater than the tooth front circular shape d5 of the tooth form simultaneously with the formation of the tooth form, and it is also possible to maintain the outer diameter d8 of the first shaft portion 36B1 of the shaft portion 36B to a value smaller than the outer diameter d7 of the guard portion 36C.

Thus, it is possible to generate a large positioning surface (a step portion) 36C1 equivalent to the diameter difference (d7−d8) in the axial direction shaft portion side of the guard portion 36C, and it is possible to perform the movement restriction of the axial direction of the inner rim 34A of the second conical roller bearing 34 by bringing the inner rim (the fitting member) 34A of the second conical roller bearing 34 into contact with the positioning surface 36C1. That is, in the present embodiment, as mentioned above, between the guard portion 36C and the end surface 12C of the carrier body 12, the inner rim 34A of the second conical roller bearing 34 and the spacer 37 is interposed by the fastening of the bolt 14 using the positioning function, and the positioning of the axial direction (the movement restriction) of the inner rim 34A (relative to the casing 48) together with the spacer 37 is performed.

Furthermore, since it is possible to increase the outer diameter d8 of the first shaft portion 36B1 (not only smaller than the root circle diameter d6, but also greater than the tooth front circular shape d5), the inner diameter D3 of the second conical roller bearing 34 can be considerably increased. As a result, even in the rotational direction of any one of forward direction and a reverse direction, it is possible to satisfactorily receive the engagement reaction of the gear by the first and second conical roller bearings 24 and 34.

Moreover, since the bevel pinion portion (the gear portion) 36A is formed by forging, an effect is obtained in which mechanical property and durability are improved by a continuous organization. Furthermore, since there is no need to secure a space for the removal of a tool owing to the forging while having the guard portion 36C and the first shaft portion 36B1 having the outer diameter d7 greater than the tooth front circular shape d5 of the tooth form, the length of the axial direction of the shaft member 36 is not particularly increased compared to the related art (an example of FIG. 6).

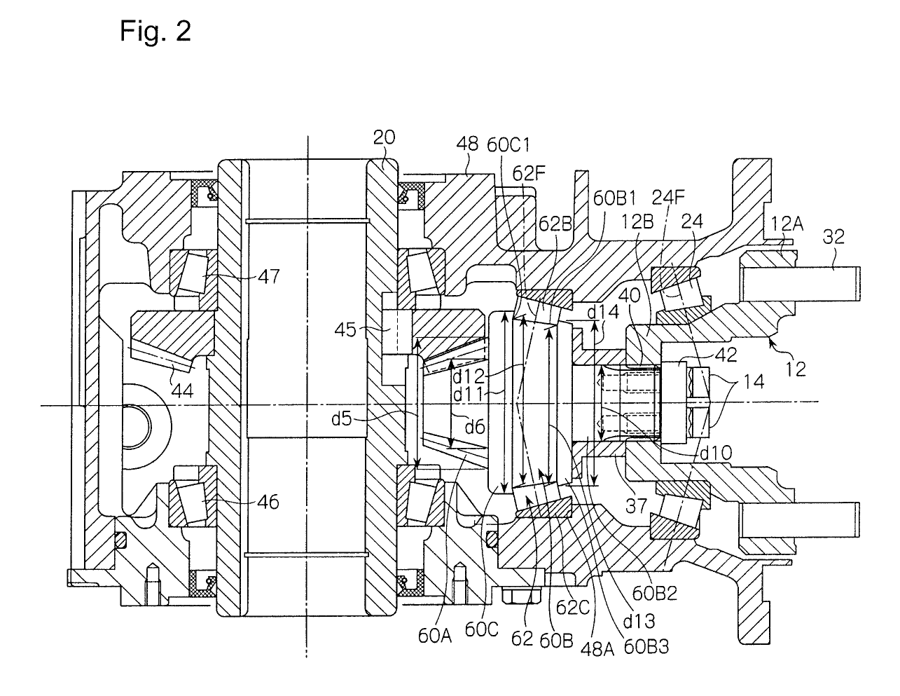

Next, an example of another embodiment of the present invention will be described with reference to FIG. 2.

Even in the embodiment, the shaft member 60 is formed by plastic working by the forging. The shaft member 60 includes a bevel pinion portion (a gear portion) 60A and a shaft portion 60B that is formed continuously and integrally with the bevel pinion portion 60A. Furthermore, in the axial direction shaft portion side of the bevel pinion portion 60A, a guard portion 60C of the outer diameter d11 is formed which is protruded from the addendum circle (the addendum circle diameter d5) of the bevel pinion portion 60A to the outer side of the radial direction. The shaft portion 60B has a protrusion portion 60B3 between the first shaft portion 60B1 of the gear portion side and a second shaft portion 60B2 of the carrier body side.

In the embodiment, the outer diameter of the first shaft portion 60B1 becomes a slope surface having a shape in which, as the outer diameter goes away from the guard portion 60C, d12 is decreased to d13. The sloped first shaft portion 60B1 constitutes a rolling surface (of the inner rim side) of the second conical roller bearing 62. For this reason, the guard portion 60C of the shaft member 60 is formed so as to be slightly thicker than the preceding embodiment in the axial direction. This is to permit the thrust force of the conical roller 62B of the second conical roller bearing 62 to be reliably received by the guard portion 60C. In the end portion (the diameter d13) of the counter guard portion side of the sloped first shaft portion 60B1, the protrusion portion 60B3 (the outer diameter d14) is formed (d14>d13) to perform the position restriction of the counter guard portion side of the conical roller 62B. In addition, the second shaft portion 60B2 of the carrier body 12 side of the shaft portion 60B has the same size (the diameter d10) as that of the second shaft portion 36B2 of the preceding embodiment.

In the present embodiment, the conical roller 62B of the second conical roller bearing 62 rolls on the outer periphery of the first shaft portion 60B1 of the shaft portion 60B. The conical roller 62B is configured so that the movement in the axial direction (to the left side of FIG. 2) is restricted by coming into contact with the positioning surface (the step portion) 60C1 of the guard portion 60C. That is, in the embodiment, the conical guard 62B of the second conical roller bearing 62 is equivalent to the fitting member of an embodiment of the present invention. The conical roller 62B of the second conical roller bearing 62 is configured so that the positioning of the axial direction is performed by being interposed between the guard portion 60C and the protrusion portion 60B3. In addition, the outer rim 62C of the second conical roller bearing 62 is incorporated so that it can receive the thrust force to the axial direction counter guard portion side by coming into contact with the step portion 48A of the casing 48.

Even in the present embodiment, it is possible to satisfactorily receive the engagement reaction of the gear by the first conical roller bearing and the second conical roller bearing 62, and it is possible to further reduce the number of components as compared to the embodiment mentioned above.

Since other configurations are identical to those of the preceding embodiment, substantially the same portions as the preceding embodiment in FIG. 2 are denoted by the same reference numerals and the overlapped description will be omitted.

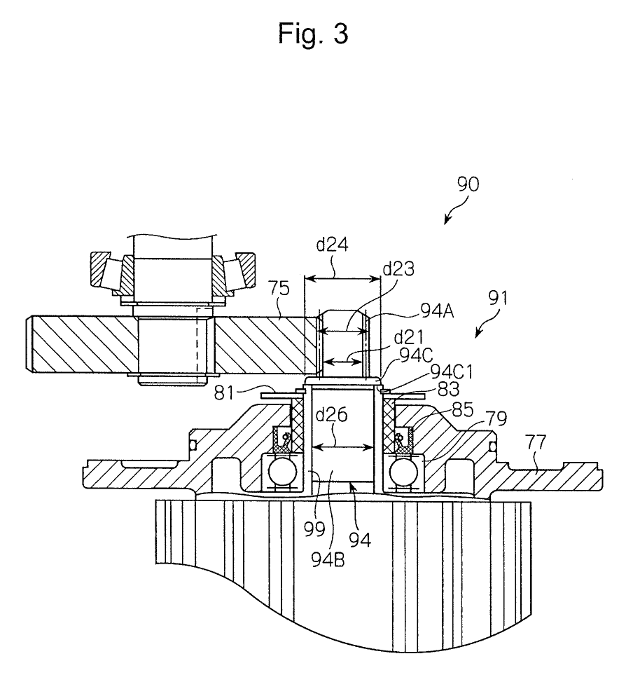

FIG. 3 shows an example of still another embodiment of the present invention.

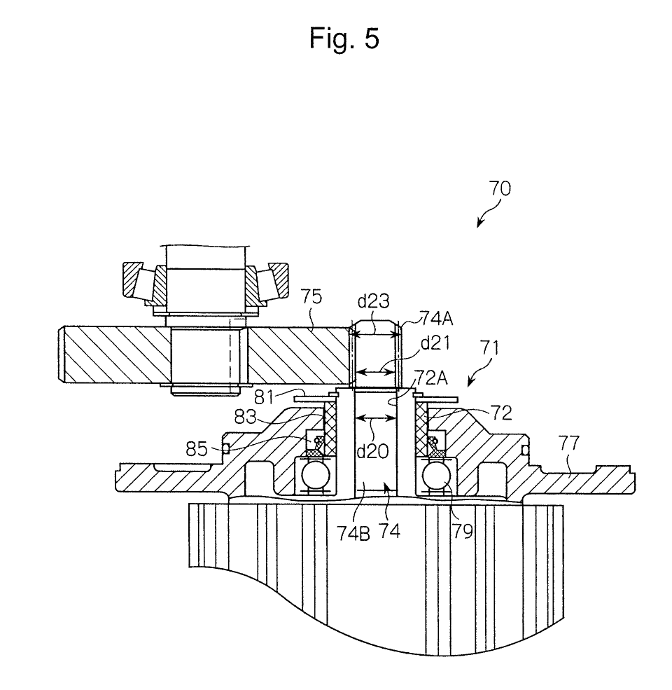

A gear device 90 according to the embodiment is equivalent to a case where the configuration as shown in FIG. 3 can be obtained by applying the input portion 71 of the gear device 70 configured as shown in FIG. 5 in the related art to the embodiment of the present invention.

Firstly, a configuration of the related art of Fig. will be simply described. The input portion of the deceleration device 70 forms a joint shaft (or it maybe a motor shaft) 72 connected to a motor shaft (not shown) as a hollow (hollowness). The shaft member 74 is connected to the hollow portion 72A of the joint shaft 72 by pressure fitting. The shaft member 74 includes a helical pinion portion (the gear portion) 74A, and a shaft portion 74B that is formed continuously and integrally with the helical pinion portion 74A. Since the helical pinion portion 74A (of the related art) is formed by cutting, in order to secure a space of the removal of a tool, the outer diameter d20 of the shaft portion 74B is approximately the same as the root circle diameter d21 of the helical pinion portion 74. For that reason, when there is a need to reduce the number of teeth of the helical pinion portion 74A (that is, reduce the root circle diameter d21) in the relationship with the deceleration ratio realized by the engagement with the helical gear 75, it is difficult to also reduce the outer diameter d20 of the shaft portion 74B accordingly.

In addition, reference numeral 77 of FIG. 5 is a front cover of the gear device 70 also functioning as a motor cover, reference numeral 79 is a bearing, reference numeral 81 is a beating plate of lubricant, reference numeral 83 is a spacer, and reference numeral 85 is an oil seal.

On the contrary to this, in the input portion 91 of the gear device 90 corresponding to the embodiment of the present invention shown in FIG. 3, a helical pinion portion 94A to the shaft member 94 is formed by plastic working by the rolling. In the plastic working by the rolling, for example, as shown in FIG. 4B, firstly, a material including a large diameter portion 96C (the diameter d24) becoming the guard portion 94C in the middle portion of the axial direction is prepared as the shaft material 96. Next, rolling molds 97 and 98 are strongly pushed from the radial direction outer side of an end portion 96A becoming the helical pinion portion 94A to the outer periphery of the shaft material 96 while rotating the shaft material 96.

At this time, the large diameter portion 96C of the shaft material 96 remains as the guard portion 94C of the outer diameter d24 greater than the addendum circle diameter d23 of the helical pinion portion 94Abin that state, and the small diameter portion 96B of the outer diameter d26 smaller than the outer diameter d24 of the guard portion 94C is connected to the guard portion 94C as the shaft portion 94B and remains in that state. As a result, it is possible to form the shaft member 94, which includes the helical pinion portion (the gear portion) 94A and the shaft portion 94B formed consecutively and integrally with the helical pinion portion 94A, by plastic working (the rolling).

According to the embodiment, even when the root circle diameter d21 of the helical pinion portion 94A is small, for example, in the relationship of the deceleration ratio, it is possible to form the shaft member 94 including the guard portion 94C greater than the root circle diameter d21 and the addendum circle diameter d23.

Returning to FIG. 3, in the present embodiment, the fitting member to be fit into the shaft member 94 according to an embodiment of the present invention is a hollow joint shaft (or a hollow motor shaft) 99. Since the positioning surface (the step portion) 94C1 exists in the guard portion 94C of the shaft member 94, it is possible to restrict the movement of the joint shaft 99 in the axial direction as the fitting member by the positioning surface 94C1. Furthermore, since the helical pinion portion (the gear portion) 94A is formed by plastic working by the rolling using the shaft material 96 having the large diameter portion 96C becoming the guard portion (94C) in advance while having the guard portion 94C of the outer diameter d24 greater than the addendum circle diameter d23 of the helical pinion portion 94A, there is no need to provide an unnecessary shaft portion for securing the removal of a tool. For this reason, it is possible to form the guard portion 94C greater than the addendum circle diameter d23 of the helical pinion portion 94A in the range of the same axial direction length as the related art.

Since other configurations are the same as those described in FIG. 5, the members having the same functions in FIG. 3 as those of FIG. 5 are denoted by the same reference numerals, and the overlapped description will be omitted.

In addition, although the shaft member having the gear portion such as the bevel pinion portion or the helical pinion portion, in which the thrust force is generated, is given as an example in the embodiment mentioned above, the gear portion according to an embodiment of the present invention is not limited to the gear portion. For example, in addition to another gear portion such as a hypoid pinion portion or a worm pinion portion in which the thrust force is generated, a gear portion such as a spur pinion portion may be adopted in which the thrust force is not generated.

The formation of the gear portion may be the forging or the rolling if the formation is by plastic working. Furthermore, a hot working or a cold working may be adopted. Furthermore, a specific method of the forging or the rolling is not also limited to the method mentioned above. That is, a suitable method may be adopted considering the tooth form of the gear portion, the required size of the guard portion or the like. In addition, as shown in the example of FIG. 3, if at least the gear portion is formed by plastic working, the formation of other portions of the shaft member may not be necessarily performed by plastic working.

Although the shaft member to be used as the input shaft (having the gear portion) of the orthogonal gear mechanism or the shaft member constituting the input portion of the gear device is described as an example in the present embodiment, the shaft member according to an embodiment of the present invention is applicable to various parts in the gear device besides them.

The fitting member is also not limited to the above example, for example, any one may be used if the fitting member is fitted into the shaft portion such as the gear and the spacer and is restricted in movement by the guard portion.

It should be understood that the invention is not limited to the above-described embodiment, but may be modified into various forms on the basis of the spirit of the invention. Additionally, the modifications are included in the scope of the invention.

What is claimed is:

1. A gear device comprising:
a shaft member including a gear portion and a shaft portion formed consecutively and integrally with the gear portion; and
a fitting member that is fitted into the shaft portion of the shaft member,
wherein, in the shaft member, at least the gear portion is formed by a plastic working,
a guard portion protruding from a addendum circle of the gear portion to an outer side in the radial direction is formed in an end portion of a shaft portion side of an axial direction of the gear portion, and
the movement in the axial direction of the fitting member is restricted by the guard portion.

2. The gear device according to claim 1,
wherein the outer periphery of the guard portion has a circular shape.

3. The gear device according to claim 1,
wherein the external diameter of the shaft portion is greater than the root circle diameter of the gear portion

4. The gear device according to claim 3,
wherein the outer diameter of the gear portion is greater than the addendum circle diameter of the gear portion.

5. The gear device according to claim 1,
wherein the gear portion is a gear in which thrust force is generated in the direction of the fitting member.

6. A method of manufacturing a shaft member having a shaft portion integrally formed with a gear portion, comprising the steps of:
preparing a material of the shaft member; and
plastically deforming the material of the shaft member by forging to form a tooth form of the gear portion, and forming a guard portion having an external diameter greater than a addendum circle of the gear portion and the shaft portion to be connected to the guard portion by an external diameter smaller than an external diameter of the guard portion.

7. A method of manufacturing a shaft member having a shaft portion integrally formed with a gear portion, comprising the steps of:
preparing a material of the shaft member including a large diameter portion of a large diameter in a middle portion of an axial direction; and
plastically deforming the material of the shaft member by rolling to form a tooth form of the gear portion in an axial direction one side of the large diameter portion, and leaving the large diameter portion as a guard portion greater than the addendum circle of the gear portion and the shaft portion connecting a counter guard portion side of the large diameter portion to the guard portion by an external diameter smaller than the external diameter of the guard portion.
